(19) United States
(12) Patent Application Publication
(10) Pub. No.: US 2007/0289235 A1
(43) Pub. Date: Dec. 20, 2007

(54) Means For Protecting A Seal Of A Pipe And/Or Cable Passageway From Heat And/Or Fire And Fire Protection Element Therefor

(75) Inventors: Jorg Hansen, Lohfelden (DE); Alexander Reim, Juhnde (DE)

Correspondence Address: PYLE & PIONTEK;ATTN: THOMAS R. VIGIL, 221 N LASALLE STREET , ROOM 2036, ROOM 2036, CHICAGO, IL, 60601, US

(73) Assignee: AIK Flammadur Brandschutz GmbH, Kassel (DE)

(21) Appl. No.: 11/791,261

(22) PCT Filed: Nov. 25, 2005
(86) PCT No.: PCT/DE05/02120

§ 371 Date: May 21, 2007

(30) Foreign Application Priority Data
Nov. 25, 2004 (DE) 10 2004 056 914.2

(51) Int. Cl. A62C 3/16

(52) U.S. Cl. 52/309.7; 169/91; 52/741.3

(57) ABSTRACT

The method for protecting a pipe and/or cable lead through from heat and/or fire by providing a heat and/or fire retardant sealing for a pipe and/or cable passageway using a dimensionally stable, deformable fire protection element using an elongate fire protection element which is laid in the pipe and/or cable passageway, the elongate fire protection element being arranged transverse to the pipeline or to the cable. The fireproof element is elongate, preferably configured in the shape of a cylinder or a bar, and has a length of from 10 cm to 150 cm, preferably of 50 cm

This application claims Priority from German Application No. DE 10 2004 056 914.2 filed on 25. Nov. 2004

### BACKGROUND OF THE INVENTION

1. Field of the Invention

The present invention relates to a fire protection element according to the preamble of claim 1, a method according to the preamble of claim 6 and a pipe and/or cable passageway according to the preamble of claim 13.

2. Description of the Prior Art

Intumescent fire protection elements that are being manufactured in various geometric shapes or as individual moulded parts are known from EP 0 400 402 B1. The thus prepared fire protection elements are used in order to seal pipe or cable passageways against heat and fire so as to retard fire spread to a neighbouring fire area in the event of a fire. In the various walls there are provided corresponding penetrations for passage of the cables or pipes. The clearance left after the pipes or cables have been laid is then closed with the fire protection elements. The prefabricated fire protection elements are custom cut and inserted into the clearance by a craftsman so that the pipe and/or cable passageway eventually complies with the corresponding standards. Conforming the fire protection elements to the local circumstances requires lots of manual work and is cost intensive as a result thereof.

### BRIEF SUMMARY OF THE INVENTION

In view thereof, it is the object of the present invention to provide a fire protection device, a pipe and/or cable passageway and a method of the type mentioned herein above by means of which low-cost and reliable heat and fire protection may be achieved for a pipe and/or cable passageway.

As a technical solution to this object, the invention proposes a fire protection element according to the features of claim 1, a method having the features of claim 6 and a pipe and/or cable passageway according to claim 13. Advantageous developed implementations will become apparent from the respective dependent claims.

A fire protection element configured in accordance with this technical teaching, a method implemented in accordance with this technical teaching and a pipe and/or cable passageway configured in accordance with this technical teaching have the advantage that an elongate fire protection element, which is preferably configured in the shape of a cylinder or a bar and has a length of preferably 50 cm, is suited for sealing the current pipe and/or cable passageways without the fire protection element having to be cut to size on the site.

It has thereby been found advantageous to lay this elongate fire protection element transverse to the pipe or the cable. This provision offers the great advantage that the elongate fire protection element may at first be inserted at one end into the pipe and/or cable passageway before it can be wound around the pipe or cable and be completely pressed into the pipe and/or cable passageway. Accordingly, by having the fire protection element arranged transverse to the pipe and/or cable, said fire protection element needs not be tediously processed on the site. The fire protection element is standardized instead and suited for a large number of applications in the manner mentioned herein. The only thing the craftsman needs to do is to cut the fire protection element of the invention to the right length, and even this is not always necessary.

It has thereby been found advantageous to provide the fire protection element with a thickness ranging between 0.5 cm and 10 cm, preferably with a thickness of 5 cm, as such a fire protection element may still be bent and introduced readily into the pipe and/or cable passageway.

In another preferred embodiment, the length-to-thickness ratio of the fire protection element ranges between 5:1 and 15:1 and is preferably 10:1. With such dimensions, the standardized fire protection element obtained may be utilized in most of the application cases without having to rework it on the site. Accordingly, the mounting cost is considerably reduced.

In still another preferred embodiment, the fire protection element is adapted for axial compression. The advantage thereof is that the fire protection element may thus be shortened in length without having to perform complicated cuts. In other words, this means that for insertion of the fire protection element into the clearance between the pipe and/or cable on the one side and the wall on the other side, the fire protection element may be compressed until it is completely received within the pipe and/or cable passageway. To shorten the length by compression offers the advantage that in many cases cutting to length is no longer necessary on the one side and that on the other side there is more than enough material in the pipe and/or cable passageway to achieve sufficient heat and fire protection in case of an emergency.

In another preferred embodiment, the fire protection element is adapted for local radial pressure. As a result, it is possible to insert this fire protection element also in such clearances in the pipe and/or cable passageway that are smaller than the diameter of the fire protection element so that in this case as well adjustment of the fire protection element to the clearance in the pipe and/or cable passageway by cutting material away is no longer necessary. Moreover, this also provides for enough material in the clearance in the case of an emergency.

It is understood that the fire protection element substantially keeps its shape when compressed axially or pressed radially. This of course does not exclude slight cross section changes.

For introducing the fire protection element into the pipe and/or cable passageway, it has been found advantageous to cut the fire protection element to length to such an extent that the fire protection element may be placed around the pipe and/or cable so as to surround it, at least for its major part. It is thereby not compulsory that the fire protection element surrounds the pipe and/or cable without any gap for a small gap may still be closed by the material, which swells in the event of a fire. It is thereby to be taken into consideration that the size of the gap is chosen to allow it to be filled with the foaming material in the event of a fire. The advantage thereof is that there is no need of too much care in mounting the fire protection element, this in turn facilitating mounting and reducing the mounting costs.

This applies in analogous fashion for other clearances as well, which remain after having laid the fire protection element into the pipe and/or cable passageway. As long as these clearances are filled with the material which is intended to swell at a later stage, these are negligible. In consideration thereof, the fire protection element of the invention has been found particularly advantageous because this allows for fast and simple insertion of the fire protection elements into the pipe and/or cable passageways.

This fire protection element of the invention may either be wound about the pipe and/or cable so that the end sides abut each other or so that one end side comes to rest against a wall so that the other end side of the fire protection element comes to rest against an outer side of the fire protection element after it has been wound about the pipe and/or cable. Both methods are fast and easy to carry out. In both cases, the pipe and/or cable passageway is sufficiently closed because the fire protection element, which swells in the case of an emergency, then closes the pipe and/or cable passageway sufficiently. Accordingly, the standardized fire protection element of the invention further contributes to fast and easy mounting.

It is understood that, with larger pipes and/or cables or with a plurality of pipes and/or cables, two or more fire protection elements may also be utilized in order to completely surround the bundle of pipes and/or cables. This applies in analogous fashion if the clearance between pipe and/or cable on the one side and the wall on the other side is so large that it cannot be filled with only one fire protection element. In this case, a second or third etc. fire protection element is inserted in the plane of the wall, with the second fire protection element surrounding the first fire protection element.

It is obvious therefrom that large pipe and/or cable passageways may also be quickly and readily closed with the fire protection element of the invention. Accordingly, the herein standardized fire protection element may be utilized universally and contributes to considerably reduce the cost for sealing pipe and/or cable passageways so as to comply with fire protection standards.

Further advantages of the fire protection element of the invention, the pipe and/or cable passageway of the invention and the method of the invention will become apparent in the appended drawings and in the following description of embodiments thereof. Likewise, the invention lies in each and every novel feature or combination of features mentioned above or described herein after. The embodiments discussed herein are merely exemplary in nature and are not intended to limit the scope of the invention in any manner.

### BRIEF DESCRIPTION OF THE SEVERAL VIEWS OF THE DRAWING

FIG. 1 is a perspective illustration of a first embodiment of a fire protection element of the invention;

FIG. 2 is a perspective illustration of a second embodiment of a fire protection element of the invention;

FIG. 3 is a side view of a first embodiment of a cable passageway of the invention;

FIG. 4 is a side view of a second embodiment of a cable passageway of the invention;

FIG. 5 is a side view of a third embodiment of a cable passageway of the invention;

FIG. 6 is a side view of a fourth embodiment of a cable passageway of the invention;

FIG. 7a is a sectional side view of a fifth embodiment of a cable passageway of the invention at a first instant in time;

FIG. 7b is a sectional side view of the cable passageway shown in FIG. 7a at a second instant in time.

### DETAILED DESCRIPTION OF THE INVENTION

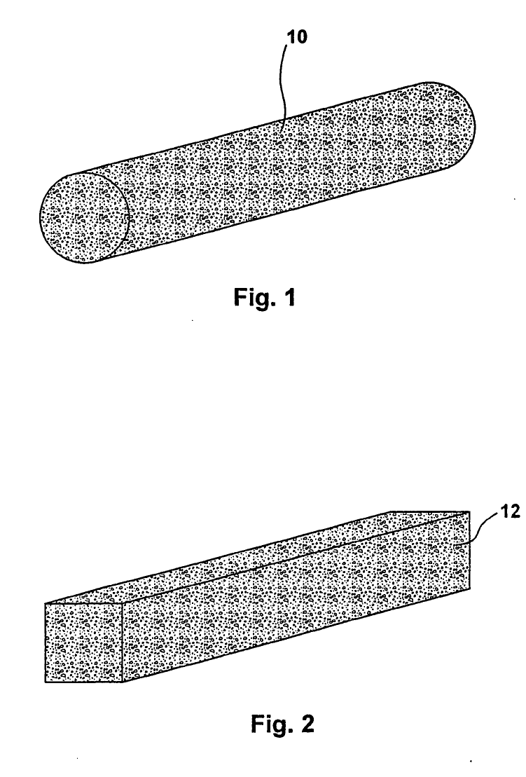

FIG. 1 shows a first embodiment of a fire protection element of the invention. This fire protection element 10 is configured to be cylindrical, is 50 cm in length and has a diameter of 5 cm. This fire protection element 10 is formed from intumescent foam that foams up to a multiple of its volume without burning under the action of intense heat. This fire protection element then deforms but remains a cohesive part with high insulation capacity.

This inherently stable deformable fire protection element 10 may be pressed locally in the radial direction or compressed in the axial direction without damage thereto. After the application of this radial or axial force has been ended, the fire protection element returns to its original cylindrical shape. It is understood that, when axially compressed for example, the diameter of the fire protection element 10 slightly increases at the place of concern. This applies in analogous fashion to radial pressure. The fire protection element 10 still remains substantially cylindrical. This fire protection element 10 is also flexible and bendable to a large extent so that it may be wound around pipes or cables.

In FIG. 2, there is represented a second embodiment of a fire protection element of the invention. This fire protection element 12 only differs from the fire protection element 10 shown in FIG. 1 by the fact that it does not have a round but a square cross section.

In other embodiments that have not been illustrated herein, the fire protection element may also have another cross section such as an oval, a semi-circular, a triangular, a pentagonal, a hexagonal or the like cross section. It is also conceivable that the fire protection element be configured to be profiled.

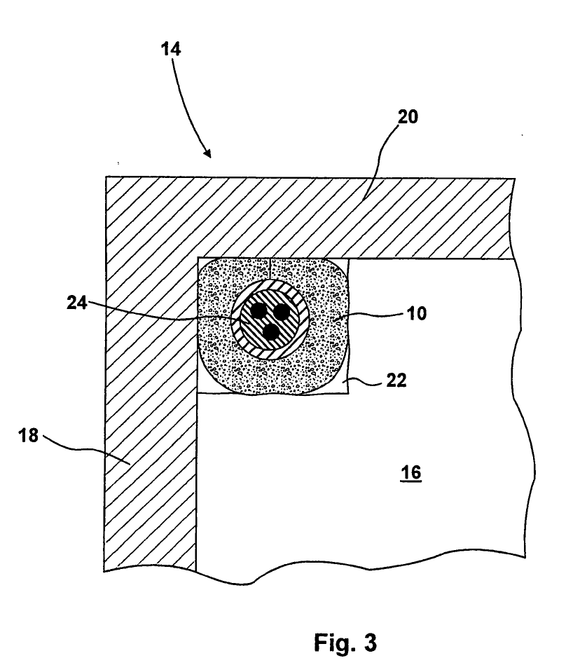

The fire protection elements 10, 12 are standardized in such a manner that they can be utilized universally for sealing pipe and/or cable passageways. In the FIGS. 3 through 6 there are shown various examples of application. FIG. 3 schematically shows a cable passageway 14 as it often occurs in structural engineering and in shipbuilding. A clearance 22 through which a cable 24 is laid is thereby provided in a corner of a wall 16, near a side wall 18 and a ceiling 20.

In another embodiment that has not been illustrated herein, a pipe or a number of cables and pipes is laid there.

In order to prevent fire or heat from passing through the clearance 22 needed for laying the cable 24 in case of an emergency, this clearance 22 must be sealed according to the fire protection regulations. For this purpose, the standardized fire protection element 10 is wound in such a manner around the cable 24 that the fire protection element 10 almost completely surrounds the cable 24. Concurrently, the fire protection element 10 is introduced into the clearance 22 formed between the cable 24 and the wall 16, the lateral wall 18 and the ceiling 20. The fire protection element is thereby laid transverse to the direction of the cable 24. The fire protection element 10 is deformed when being introduced into the clearance 22. This is to say that the fire protection element 10 is radially pressed and also generally axially compressed in some places. As a result, the fire protection element 10 adapts to the local circumstances of the clearance 22 without any works having to be performed on the fire protection element 10. The fact that the clearance 22 is not completely filled with the fire protection element 10 is not a problem as long as the remaining clearances are small enough to be filled with the foaming fire protection element 10 in the event of a fire.

As can be readily seen from FIG. 3, the fire protection element 10 may be readily wound around the cable 24 and introduced into the clearance 22. As a result, the standardized fire protection element 10 allows for fast, simple and low-cost mounting.

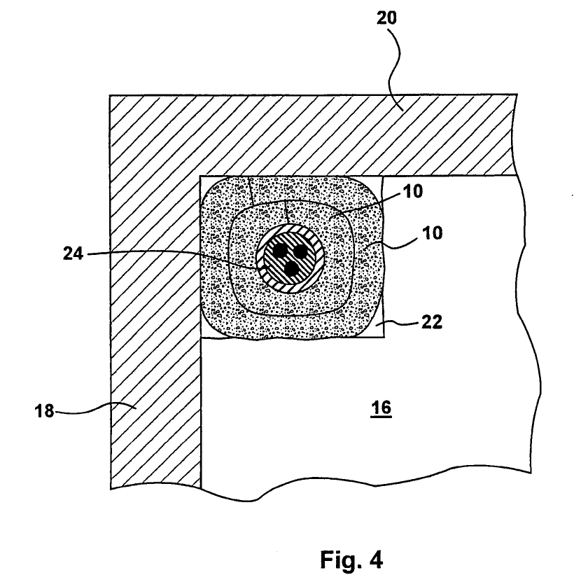

As can be seen from the embodiment shown in FIG. 4, the fire protection element 10 of the invention may also serve to seal larger clearances 26 by arranging two such fire protection elements 10 side-by-side. The first fire protection element 10 thereby surrounds the cable 24 whilst the second fire protection element 10 is wrapped around the first fire protection element 10. It may thereby be necessary to shorten somewhat the fire protection element 10 since compression of the fire protection element 10 is only possible to a certain extent.

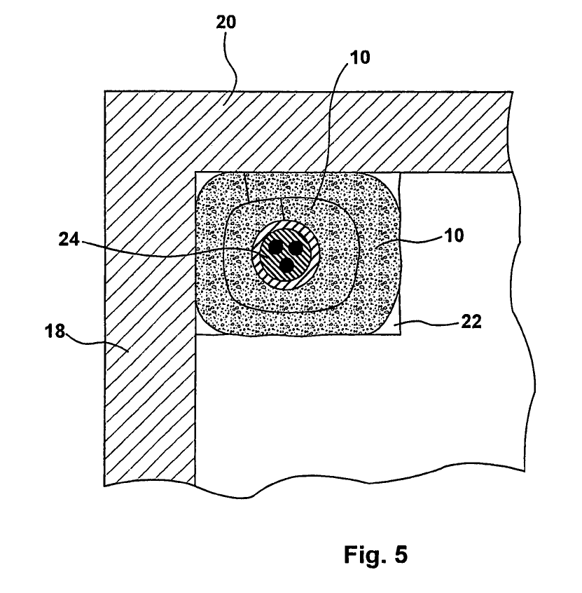

In the embodiment shown in FIG. 5, the cable 24 is not laid in the center of the clearance 22 with the two fire protection elements 10 being allowed to still properly fill the clearance. The fire protection elements 10 are thereby retained pressed into the clearance 22 on the side turned toward the side wall 18.

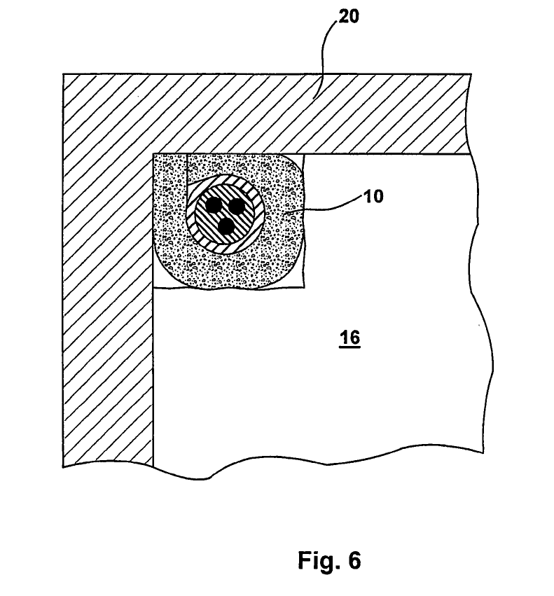

In the embodiment shown in FIG. 6, the fire protection element 10 is laid so as to have one end side abutting the ceiling 20 whilst the other end side of the fire protection element 10 comes to rest against a surface of the fire protection element 10.

In another embodiment that has not been illustrated herein, the fire protection element 10 may also be wrapped around two or more cables and seal the remaining clearance.

In still another embodiment that has not been illustrated herein, large pipes or cables can be enlaced by means of two fire protection elements laid one behind the other.

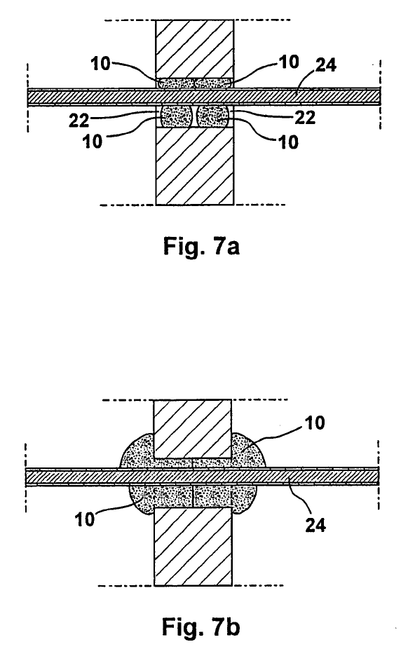

In the FIGS. 7a and 7b there is shown another embodiment in which two fire protection elements are arranged in a parallel side-by-side arrangement so as to seal the clearance 22. One part of the fire protection element 10 is thereby strongly radially compressed whilst the opposite part of the fire protection element 10 is laid approximately in its original state. In FIG. 7a, the normal situation is shown whilst FIG. 7b shows the situation after the action of heat. The fire protection element 10 has now foamed up under the action of heat and its volume has increased. Since there was not enough space available in the clearance 22 to receive the now enlarged fire protection element 10, parts of said fire protection element 10 have now oozed to the right and to the left out of the clearance 22. It appears quite clearly that both a strongly compressed fire protection element 10 and a fire protection element 10 left in its original state have very good sealing properties.

As can be seen from the exemplary embodiments illustrated herein, the fire protection element 10 of the invention, which has been standardized for these purposes of utilization, (as well as the fire protection element 12) may be utilized universally, quickly and simply for sealing pipes and/or cable passageways. It is thereby not necessary that the respective clearance be precisely filled so that the processing of the fire protection elements known from prior art may be obviated. Another advantage of the fire protection element of the invention is that only one single geometric shape needs be produced and provided, which may be used in all the cases of application. This also reduces the manufacturing and storage costs.

In another embodiment that has not been illustrated herein, the fire protection element is configured in the dimensions 10 mm in width, 50 mm in height and 500 mm in length. In an alternative, the fire protection element may also have a width of 16 mm. With this fire protection element, smaller openings, clearances or joints may be filled.

Example for manufacturing a fire protection element in accordance with the invention:

A liquid mixture made from:

| | | |
|---|---|---|
| 46.76 | g | of Bayfomox PA (Fire protection mixture of Lanxess |
| | | Deutschland GmbH, formerly Bayer AG) |
| 131.86 | g | of a mixture of polyethylene glycol, polyether |
| | | polyol (diol) with a OH number of 250-270 and N,N- |
| | | dihydroxyethyl-aminomethane phosphonic acid-diethyl |
| | | ester |
| 40.77 | g | of a mixture of melamine phosphate and ethylene |
| | | diamine phosphate |
| 13.09 | g | of aluminium hydroxide |
| 1.30 | g | of iron oxide red |
| 46.76 | g | of expanded graphite (e.g. Nordmin NM 248) |
| 0.94 | g | of water |

are thoroughly mixed using an automatic dosing and mixing machine by adding 93.52 g of methylene diphenyl diisocyanate (MDI) to the mixture and poured into a mould with the inner dimensions 50 mm×60 mm×500 mm and the mould is closed. The mixture foams up in the mould and after about 15 min a moulded part having these dimensions can be removed therefrom, said part consisting of flexible soft foam and having a density of 250 g/L.

With fire protection elements of the construction described herein above, fire tests were performed according to ASTM E 814/UL 1479 Fire Test Standard. For this purpose, pipes made from different materials and having different diameters were passed through openings in a concrete wall of 113 mm thick and the remaining circular gap between the pipe and the wall of the opening was closed with a fire protection element of the invention. The pipes were not always mounted in the center so that the circular clearances were not always regular. Next, one side of the wall was exposed to fire in a test furnace and the time was measured in which no smoke and no fire passed through the penetrations to the side turned away from the fire (F-rating).

After a maximum of two hours, this test was ended and then a water jet was directed onto the penetrations; it was expected that no water would pass through the penetrations (Hose-Stream Test).

Table 1 summarizes the structures and the results of some of these fire tests:

TABLE 1

| | | Dimensions | | | | |
|---|---|---|---|---|---|---|
| Pipe | | of the | | Mount- | | Hose- |
| material/ | | circular | | ing | F- | Stream |
| diameter | Insulation | clearance | | depth | Rating | Test |
| Copper/ | none | 31.4 | mm | 50 mm | 2 h | passed |
| 113 mm | | | | | | |
| Copper/ | none | 0-59.6 | mm | 50 mm | 2 h | passed |
| 113 mm | | | | | | |
| Copper/ | none | 25.1 | mm | 50 mm | 2 h | passed |
| 75.3 mm | | | | | | |
| Copper/ | none | 0-72.2 | mm | 50 mm | 2 h | passed |
| 75.3 mm | | | | | | |
| Copper/ | Armaflex | 31.4 | mm | 50 mm | 2 h | passed |
| 50 mm | 18.8 mm | | | | | |
| ccPVC/ | none | 31.4 | mm | 50 mm | 2 h | passed |
| 37.7 mm | | | | | | |

| | | | | | |
|---|---|---|---|---|---|
| EMT/ | none | 12.5 mm-31.4 mm | 50 mm | 2 h | passed |
| 50 mm | | | | | |

### LIST OF NUMERALS

10 fire protection element

12 fire protection element

14 cable passageway

16 wall

18 side wall

20 ceiling

22 clearance

24 cable

1-16. (canceled)

17. A fire protection element made from intumescent foam for the heat and flame retardant sealing of pipe or cable passageways, said fire protection element (10, 12) being dimensionally stable but deformable,
characterized in
that the fire protection element (10, 12) is configured in the shape of a cylinder or a bar, and has a length of from 30 cm to 150 cm, whereby the length-to-thickness ratio of the fire protection element (10, 12) ranges between 5:1 and 15:1.

18. The fire protection element as set forth in claim 17, wherein the length is approximately 50 cm.

19. The fire protection element as set forth in claim 17, wherein the thickness ratio is approximately 10:1

20. The fire protection element as set forth in claim 17,
characterized in
that the fire protection element (10, 12) has a diameter or a cross section of from 2 cm to 10 cm.

21. The fire protection element as set forth in claim 20, wherein said diameter is approximately 5 cm

22. The fire protection element as set forth claim 17,
characterized in
that the fire protection element (10, 12) is adapted for axial compression.

23. The fire protection element as set forth in claim 17,
characterized in
that the fire protection element (10, 12) may be pressed locally in the radial direction.

24. A method of providing a heat and fire retardant sealing for one of a pipe or a cable passageway using a dimensionally stable, deformable fire protection element (10), in particular using a fire protection element (10) made from intumescent foam,
characterized in
that said fire protection element (10) is configured in the shape of a cylinder or a bar is laid in the pipe or cable passageway (14), wherein said fire protection element (10) being arranged transverse to the pipeline or to the cable (24) and is laid in such a manner that the two end sides of the fire protection element (10) abut each other.

25. The method as set forth in claim 24,
characterized in
that the fire protection element (10) is placed around the pipe or the cable (24) and surrounds it/them for at least its/their major part.

26. The method as set forth in claim 24,
characterized in
that the fire protection element (10) is placed around the pipe or the cable (24) in a state of being at least partially axially compressed and Is inserted into the pipe or cable passageway (14).

27. The method as set forth in claim 24,
characterized in
that the fire protection element (10) is placed around the pipe or cable (24) in a state of being radially pressed and is inserted into the pipe or cable passageway.

28. The method as set forth in claim 24,
characterized in
that a second fire protection element (10) is placed around the pipe or cable (24) and around the first fire protection element (10).

29. A method of providing a heat and fire retardant sealing for one of a pipe or cable passageway using a dimensionally stable, deformable fire protection element (10), In particular using a fire protection element (10)
characterized in
that a fire protection element (10) configured in the shape of a cylinder or a bar is laid in the pipe or cable passageway (14), wherein said fire protection element (10) being arranged transverse to the pipeline or to the cable (24) and is laid in such a manner that a first end side of the fire protection element (10) comes to rest against a wall in the region of the pipe or cable passageway (14) whilst a second end side comes to rest against a surface of the fire protection element (10).

30. The method as set forth in claim 29
characterized in
that the fire protection element (10) is placed around the pipe or the cable (24) and surrounds it/them for at least its/their major part.

31. The method as set forth in claim 29,
characterized in
that the fire protection element (10) is placed around the pipe or the cable (24) in a state of being at least partially axially compressed and is inserted into the pipe or cable passageway (14).

32. The method as set forth in claim 29,
characterized in
that the fire protection element (10) is placed around the pipe or cable (24) in a state of being radially pressed and is inserted into the pipe or cable passageway.

33. The method as set forth in claim 29,
characterized in
that a second fire protection element (10) is placed around the pipe or cable (24) and around the first fire protection element (10).

34. A pipe or cable passageway,
characterized in
that, in the clearance between a pipe or a cable (24) on the one side and a wall (16), a side wall (18) and a ceiling (20) on the other side, there is inserted at least one elongate fire protection element (11) made from intumescent foam for the heat and flame retardant sealing of pipe or cable passageways and, said fire protection element (10, 12) being dimensionally stable but deformable and being configured in the shape of a cylinder or a bar, and having a length of from 30 cm to 150 cm, whereby the length-to-thickness ratio of the fire protection element (10, 12) ranges between 5:1 and 15:1, said elongate fire protection element (10) being arranged transverse to the pipe or to the cable (24) and filling the clearance between the pipe or the cable (24) on the one side
and the wall (16), the side wall (18) and the ceiling (20) on the other side, at least for their major part thereof.

35. The pipe or cable passageway as set forth in claim 34,
characterized in
that the fire protection element (10) is locally compressed in the radial direction.

36. The pipe or cable passageway as set forth in claim 34,
characterized in
that, in the clearance between the pipe or the cable (24) on the one side and a wall (16), a side wall (18) and a ceiling (20) on the other side, there are inserted side-by-side two elongate fire protection elements (10).

37. The pipe or cable passageway as set forth in claim 34,
characterized in
that the fire protection element (10) is inserted in an axially compressed state.
